(19) United States
(12) Patent Application Publication
(10) Pub. No.: US 2026/0156079 A1
(43) Pub. Date: Jun. 4, 2026

(54) PRIORITIZED SCHEDULING FOR 5G LOW LATENCY, LOW LOSS, SCALABLE THROUGHPUT

(71) Applicant: T-Mobile Innovations LLC, Overland Park, KS (US)

(72) Inventors: Mochamad MIRZA, Bothell, WA (US); Liezel REOGANIS, Redmond, WA (US)

(21) Appl. No.: 18/966,508

(22) Filed: Dec. 3, 2024

(51) Int. Cl. H04L 47/127; H04L 47/11; H04L 47/24

(52) U.S. Cl. CPC H04L 47/127; H04L 47/11; H04L 47/24

(57) ABSTRACT

Systems and methods are provided for controlling network congestion. A processor is configured by machine-readable instructions to communicate data packets between a wireless network and user equipment (UE), receive a notification of wireless network congestion for the wireless network, determine the data packets are low latency, low loss, scalable (L4S), and apply a network congestion control algorithm to the data packets. The network congestion control algorithm includes priority scheduling of the data packets.

### TECHNICAL BACKGROUND

A wireless network, such as a cellular network, can include an access node (e.g., wireless access node) serving multiple wireless devices or user equipment (UE) in a geographical area covered by a radio frequency transmission provided by the access node. Access nodes may deploy different carriers within the cellular network utilizing different types of radio access technologies (RATs). RATs can include, for example, 3G RATs (e.g., GSM, CDMA etc.), 4G RATs (e.g., WiMax, LTE, etc.), and 5G RATs (new radio (NR)).

Further, different types of access nodes may be implemented for deployment for the various RATs. For example, a next generation NodeB (gNodeB or gNB) may be utilized for 5G RATs. Deployment of the evolving RATs in a network provides numerous benefits. For example, newer RATs may provide additional resources to subscribers, faster communications speeds, and other advantages.

Although 5G RATs boost network capacity and communication speeds, the 5G RATs can become congested and experience packet loss as applications require more bandwidth and speed for communicating data. Low Latency, Low Loss, Scalable Throughput (L4S) technology is used to improve the performance of the 5G RATs by reducing latency, minimizing packet loss, and maintaining high throughput, especially in congested networks. L4S is designed to enhance the responsiveness of real-time applications like video conferencing, online gaming, and virtual reality, while also benefiting cloud services and other data-intensive tasks. Nevertheless, while L4S improves performance, its congestion-control mechanism reduces the bitrate to maintain low latency, jitter, and packet loss, leading to lower resolution for video traffic. There is a need for a solution that retains the enhanced performance of L4S without reducing the bitrate of data transmission.

### OVERVIEW

One aspect of the present disclosure relates to a system configured for congestion control in a wireless network. The system may include one or more hardware processors configured by machine-readable instructions. The processor(s) may be configured to communicate data packets between a wireless network and user equipment (UE), receive notification of wireless network congestion for the wireless network, determine the data packets are L4S, and apply a network congestion control algorithm to the data packets. The network congestion control algorithm may comprise priority scheduling of the L4S data packets.

In some implementations of the system, the notification of wireless network congestion indicates a congestion control threshold has been satisfied for the wireless network. In some implementations of the system, a mechanism for the notification of the wireless network congestion is Explicit Congestion Notification (ECN). The one or more hardware processors may be configured to determine whether the data packets are L4S by using two bits in an internet protocol (IP) header. In some implementations of the system, the two bits in the IP header comprise an ECN field, and the ECN field has a plurality of ECN field values. One of the plurality of ECN values may indicate wireless network congestion.

In some implementations of the system, the one or more hardware processors is configured to process the one of the plurality of ECN values indicating wireless network congestion while maintaining application data rate of the data packets. The one or more hardware processors may be configured to maintain the application data rate of the data packets in a L4S configuration profile by the priority scheduling of the data packets. Further, the priority scheduling of the data packets may comprise a priority selection of services, applications, and/or devices. The priority scheduling of the data packets may further comprise ordering and/or ranking options for the applications, services, and devices. In addition, the priority scheduling of the data packets may comprise relative priority scheduling and/or absolute priority scheduling of applications, services, and devices.

Another aspect of the present disclosure relates to a method for congestion control in a wireless network. The method may include communicating data packets between the wireless network and user equipment (UE), receiving notification of wireless network congestion for the wireless network, determining the data packets are low latency, low loss, scalable (L4S), and applying a network congestion control algorithm to the data packets. The network congestion control algorithm may comprise priority scheduling of the data packets.

Yet another aspect of the present disclosure relates to a non-transitory computer-readable storage medium having instructions embodied thereon, the instructions being executable by one or more processors to perform steps for congestion control in a wireless network. The steps may include communicating data packets between the wireless network and user equipment (UE), receiving a notification of wireless network congestion for the wireless network, determining the data packets are L4S, and applying a network congestion control algorithm to the data packets. The network congestion control algorithm may comprise priority scheduling of the data packets.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a,’ ‘an,’ and ‘the’ include plural referents unless the context clearly dictates otherwise.

### BRIEF DESCRIPTION OF THE DRAWINGS

The present disclosure can be understood from the following detailed description, either alone or together with the accompanying drawings. The drawings are included to provide a further understanding of the present disclosure and are incorporated in and constitute a part of this specification. The drawings illustrate one or more examples of the present teachings and together with the description explain certain principles and operations. In the drawings:

FIG. 1 depicts an exemplary environment for providing a user-defined data type priority scheduling in accordance with an embodiment.

FIG. 2 illustrates a system and a congestion control engine, in accordance with an embodiment

FIG. 3 illustrates a method for configuring a wireless network, in accordance with an embodiment.

FIG. 4 illustrates an IP Header, in accordance with an embodiment.

FIG. 5 depicts an exemplary priority scheduling system in accordance with an embodiment.

FIGS. 6A-C depict examples of network performance in different instances of congestion and priority.

FIG. 7 shows exemplary comparison between bit rates in L4S configuration with and without prioritization.

FIG. 8 depicts an exemplary method for providing network congestion control by prioritizing network traffic.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

In addition to the particular systems and methods described herein, the operations described herein may be implemented as computer-readable instructions or methods, and a processor on the network for executing the instructions or methods. The processor may include an electronic processor.

Existing wireless networks can become overloaded with data packets causing queueing, delay, and packet drop which negatively affect network performance. Current network configurations allow more traffic to enter the wireless network than the network can handle. In a wireless network, a 5G gNB can be a bottleneck in terms of latency and capacity.

To improve utilization of 5G resources, as an example, multiple congestion control algorithms may be used for the same application. For example, the network may be configured in the wireless network to communicate data packets between the same application and user equipment (UE). Using configuration profiles, the network is configured for different data packet types for communication between the same application and the UE. The network profile may be configured using Low Latency Low Loss Scalable Throughput (L4S). L4S improves network latency and packet loss by applying optimized congestion control (CC) algorithms for time critical applications.

When the network is configured for the same application using L4S, network RANs may be used for different data packet types and different congestion control algorithms may be applied to different data packet types. A L4S network profile may be configured in the wireless network for different data packet types. Exemplary RANs may include new radio access networks such as 5G ultra-reliable low-latency communication (URLLC), 5G enhanced mobile broadband (eMBB), and 5G massive machine-type communications (MTTC). It is costly to deploy some 5G radio access network (RAN), such as 5G URLLC, features all over the wireless network. As such, it is beneficial to separate critical content data packet types from less critical content data packet types.

An L4S profile allows a URLLC edge network to be utilized for the critical part of the extended reality (XR) content and the less costly eMBB network for less critical XR content. The network for 5G eMBB may be configured for less critical predicted/bi-directional frames of XR content. An L4S profile also allows different congestion control algorithms to be applied to different data packet types to reach the best XR resource utilization, saving deployment cost for mobile network operators (MNO).

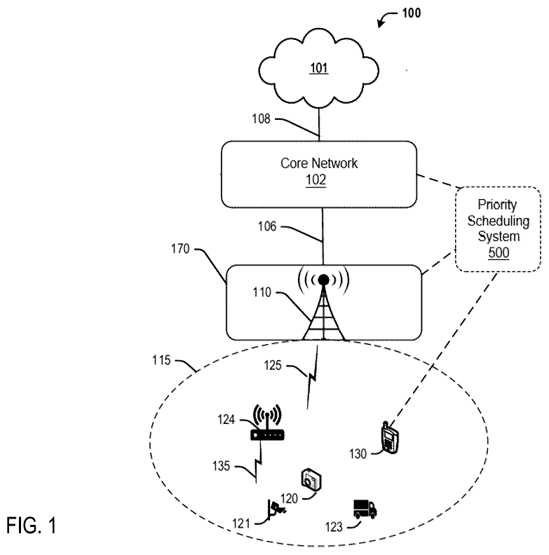

FIG. 1 depicts an exemplary environment 100 for applying different congestion control algorithms based on data packet types. In the displayed environment 100, a priority scheduling system 500 operates to assign priorities for wireless devices 120, 121, 123, and 130 within a coverage area 115. These wireless devices may be, for example, eMBB devices, IoT devices, or any other type of wireless device capable of connecting with a wireless network. In examples provided herein, the wireless device 130 may be a controlling wireless device that controls wireless devices 120, 121, and 123.

Environment 100 comprises a communication network 101, core network 102, and a radio access network (RAN) 170 including at least an access node 110. Wireless devices 120, 121, 123, and 130 communicate with the access node 110. Further, the access node may communicate with a wireless access point 124, which communicates by a wireless link 135 with the wireless devices 120, 121, 123, and 130. Further, a priority scheduling system 500 operates to enable user control of priority scheduling.

For example, a wireless network may include one or more access nodes, such as base stations including evolved NodeBs (eNBs) or next generation NodeBs (gNBs) for providing wireless voice and data service to wireless devices in various coverage areas of the one or more access nodes. As wireless technology continues to improve, various different iterations of radio access technologies (RATs) may be deployed within a single wireless network. Such heterogeneous wireless networks can include newer 5G and millimeter wave (mm-wave) networks, as well as 6G or 4G long-term evolution (LTE) access nodes.

Access node 110 can be any network node configured to provide communication between end-user wireless devices 120, 121, 123, and 130 and communication network 101, including standard access nodes and/or short range, low power, small access nodes. For instance, access node 110 may include any standard access node, such as a macrocell access node, base transceiver station, a radio base station, an eNodeB device, an enhanced eNodeB device, a next generation NodeB device (gNBs) in 5G networks, or the like.

Further the access node 110 may include multiple co-located access nodes, such as a combination of eNodeBs and gNodeBs. Access node 110 can be a small access node including a microcell access node, a picocell access node, a femtocell access node, or the like such as a home NodeB or a home eNodeB device. Moreover, it is noted that while access node 110 and wireless devices 120, 121, 123, and 130 are illustrated in FIG. 1, any number of access nodes and wireless devices can be implemented within environment 100.

The exemplary operating environment 100 may further include priority scheduling system 500, which is illustrated as operating between the communication network 101, core network 102, the RAN 170, and the wireless devices 120, 121, 123, and 130. Thus, the priority scheduling system 500 may be distributed. For example, the priority scheduling system 500 may utilize components located at any one or more of the above-described locations. Alternatively, the priority scheduling system 500 may be an entirely discrete system operating in conjunction with the communication network 101, the RAN 170, core network 102 and/or the wireless devices 120, 121, 123, 130, 131, 133.

Access node 110 can comprise a processor and associated circuitry to execute or direct the execution of computer-readable instructions to perform operations such as those further described herein. Briefly, access node 110 can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof. Access node 110 is capable of communicating with the core network 102 as well as various additional nodes including gateway nodes, controller nodes, and other access nodes.

Further, the access node 110 may communicate with the priority scheduling system 500 or alternatively may wholly or partially incorporate the priority scheduling system 500. Thus, the priority scheduling system 500 may collect data from wireless devices 120, 121, 123, and 130 and may perform processing in order to trigger traffic prioritization at the access node 110.

Wireless devices 120, 121, 123, and 130 may be any device, system, combination of devices, or other such communication platform capable of communicating wirelessly with access node 110 using one or more frequency bands deployed therefrom. For example, the wireless devices 120, 121, 123 may include IoT devices that build a network of physical objects or things that are embedded with sensors, software, and other technologies for the purpose of connecting and exchanging data with other devices and systems over the Internet or communication network 101. Cellular IoT connects physical things, such as sensors to the Internet by having them utilize the same mobile networks as wireless devices. IoT technology can be utilized to equip the “smart home,” including devices such as lighting fixtures, thermostats, home security systems and cameras. The devices can often be controlled using smartphones, such as a wireless device 130. Further, businesses, such as utility companies utilize industrial wireless sensors for reporting usage parameters and performing other necessary tasks. With either smart home or business applications, wireless devices (IoT devices) 120, 121, and 123 can be controlled by other wireless devices, which may be smart phones, laptop computers, tablets, etc.

The wireless device 130 may be, for example, an eMBB device. The wireless device 130 may be or include, for example, a mobile phone, a wireless phone, a wireless modem, a personal digital assistant (PDA), a voice over internet protocol (VoIP) phone, a voice over packet (VOP) phone, a soft phone, a home internet (HINT) device, a fixed wireless access (FWA) device as well as other types of devices or systems that can exchange audio or data via access node 110.

The core network 102 includes core network functions and elements. The core network may be structured using a service-based architecture (SBA). The network functions and elements may be separated into user plane functions and control plane functions. In an SBA architecture, service-based interfaces may be utilized between control-plane functions, while user-plane functions connect over point-to-point link. The user plane function (UPF) accesses a data network, such as network 101, and performs operations such as packet routing and forwarding, packet inspection, policy enforcement for the user plane, priority scheduling, etc. The control plane functions may include, for example, a network slice selection function (NSSF), a network exposure function (NEF), a network repository function (NRF), a policy control function (PCF), a unified data management (UDM) function, an application function (AF), an access and mobility function (AMF), an authentication server function (AUSF), and a session management function (SMF). Additional or fewer control plane functions may also be included. The AMF receives connection and session related information from the wireless devices 120, 121, 123, and 130 and is responsible for handling connection and mobility management tasks. The SMF is primarily responsible for creating, updating, and removing sessions and managing session context. The UDM function provides services to other core functions, such as the AMF, SMF, and NEF. The UDM function may function as a stateful message store, holding information in local memory. The NSSF can be used by the AMF to assist with the selection of network slice instances that will serve a particular device. Further, the NEF provides a mechanism for securely exposing services and features of the core network.

Communication network 101 can be a wired and/or wireless communication network, and can comprise processing nodes, routers, gateways, physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless devices 120, 121, 123, and 130 etc. Wireless network protocols can comprise multimedia broadcast multicast service (MBMS), code division multiple access (CDMA) 1xRTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), and Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

Communication links 106, 108 and 125 can use various communication media, such as air, space, metal, optical fiber, or some other signal propagation path, including combinations thereof. Communication links 106 and 108 can be wired or wireless and use various communication protocols such as Internet, Internet protocol (IP), local-area network (LAN), optical networking, hybrid fiber coax (HFC), telephony, T1, or some other communication format. Communication links 106 and 108 can be a direct link or might include various equipment, intermediate components, systems, and networks. Communication links 106 and 108 may comprise many different signals sharing the same link.

Other network elements may be present in environment 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between access node 110 and communication network 101.

Further, the methods, systems, devices, networks, access nodes, and equipment described above may be implemented with, contain, or be executed by one or more computer systems and/or processing nodes. The methods described above may also be stored on a non-transitory computer readable medium. Many of the elements of communication environment 100 may be, comprise, or include computers systems and/or processing nodes.

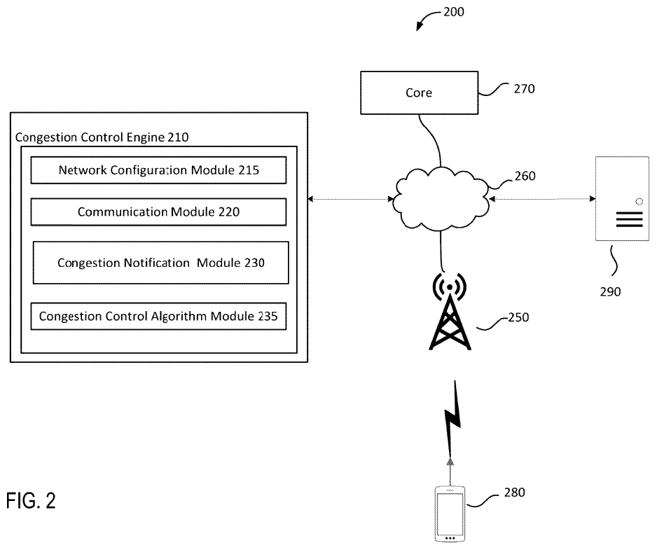

FIG. 2 illustrates a system 200 configured for routing data packets from a single application, in accordance with one or more implementations. As illustrated, system 200 comprises congestion control engine 210, an access node 250, a network 260, a core 270, which provide service in a coverage area, a UE 280, and a host application server 290. For purposes of illustration and ease of explanation, only one access node 250, UE 280 and host application server 290 are shown in the system 200; however, additional access nodes and/or application host servers and UEs may be present in the system 200.

In the illustration of FIG. 2, the access node 250 is connected to the network 260 via an NR path (including the 5G core 270). In practical implementations, the access node 250 may be connected to network 260 via multiple paths (e.g., using multiple RATs). The access node 250 may communicate with the core 270 via one or more communication links, each of which may be a direct link. However, it will be appreciated that network 260 may be any type of network facilitating communication among congestion control engine 210, access node 250, host application server 290, core 270, and UE 280.

The access node 250 may be any network node configured to provide communications between the connected wireless devices. As examples of a standard access node, the access node 250 may be a gNodeB in 5G networks. Access node 250 and core 270 may also provide data to congestion control engine 210. The congestion control engine 210 is in communication with the access node 250 and/or the core 270. The congestion control engine 210 may be configured for routing data packets from a single application.

The congestion control engine 210 can comprise one or more electronic processors and associated circuitry to execute or direct the execution of computer-readable instructions such as those described herein. In so doing, the congestion control engine 210 can retrieve and execute software from storage, which can include a disk drive, a flash drive, memory circuitry, or some other memory device, and which may be local or remotely accessible. The software may comprise computer programs, firmware, or some other form of machine-readable instructions, and may include an operating system, utilities, drivers, network interfaces, applications, or some other type of software, including combinations thereof.

As illustrated the congestion control engine 210 utilizes a modular controller, a memory, wireless communication circuitry, and a bus through which the various elements of the congestion control engine 210 may communicate with access node 250, core 270, and UE 280, host application server 290. The modular controller is one example of an electronic processor, and may include sub-modules or units, each of which may be implemented via dedicated hardware (e.g., circuitry), software modules which are loaded from the memory and processed by the controller, firmware, and the like, or combinations thereof.

While FIG. 2 illustrates network configuration module 215, communication module 220, congestion notification module 230, congestion control algorithm module 235, as being separate modules, in practical implementations some of the modules may be combined with one another and/or may share components. The network configuration module 215, communication module 220, congestion notification module 230, congestion control algorithm module 235, may be configured to perform various operations to implement methods in accordance with the present disclosure. While one example of operations performed by the modules is described here, in practical implementations at least some of the operations described as being performed by one module may instead be performed by another module, including a module not explicitly named here.

Configuration module 215 configures the network to transmit first data packet types between a single application and a UE using a first wireless network slice for a first RAN. Configuration module 215 configures the network to transmit second data packet types between the single application and the UE using a second wireless network slice for a second RAN. The first RAN and the second RAN may be new radio access networks such as 5G Enhanced Mobile Broadband (eMBB), 5G Massive Machine Type Communications (mMTC) and 5G Ultra-Reliable Low Latency Communication (uRRLC).

In one example, the network configuration module 215 configures the access node 250 such that communications between the host application server 290 and the UE 280 use multiple network slice RANs depending on the data packet type. The first RAN may be different from the second RAN. In examples, Low Latency, Low Loss, Scalable (L4S) is used to configure one or more network slices.

L4S may be an over-the-top method for rate adaptation between a UE 280 and a host application server 290. L4S may have a large buffer to have enough time to react to changes in network conditions L4S enables low latency, high-rate communications with dynamic rate adaptation to priority scheduling, even when the wireless network is loaded. L4S provides real-time dynamic rate adaptation algorithms at the application layer for priority scheduling. L4S utilizes ECN (Explicit Congestion Notification), Dual Queue Coupled Active Queue Management (AQM), and scalable congestion control algorithms to reduce latency and packet loss. The congestion control algorithms may be optimized for the wireless network.

After the 5G network is configured, communication module 220 communicates data packet types between a UE 280 and host application server 290 using a wireless network for a RAN. The single application may be an extended reality or gaming application. Congestion notification module 230 may be configured to receive a notification of wireless network congestion for the wireless network. The notification of wireless network congestion may indicate a congestion control threshold has been satisfied for the data packet types.

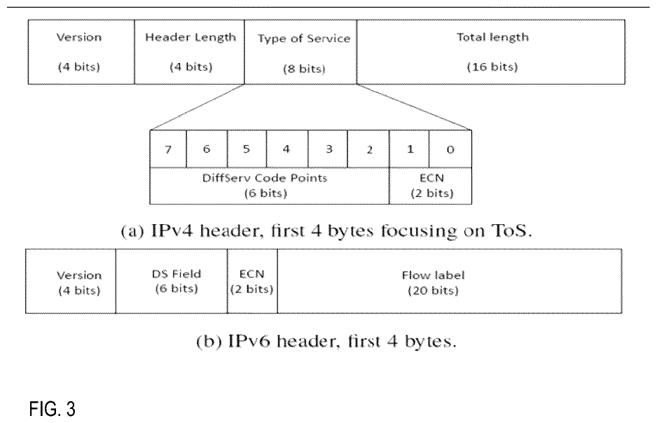

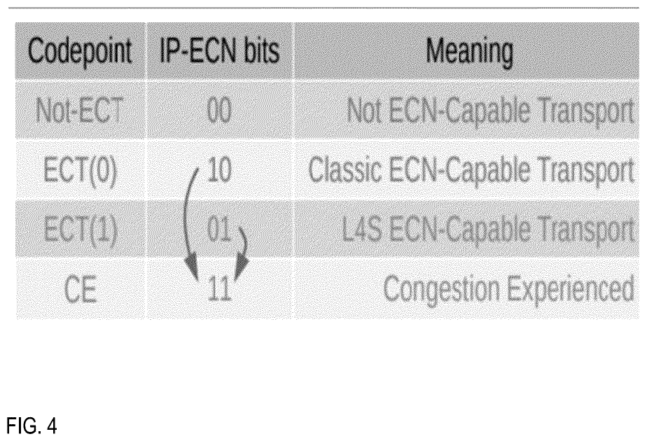

Classic TCP/IP networks signal congestion by dropping packets. ECN aware node sets up a marker in the IP header. A receiver sends a congestion indication to the sender who reduces its transmission rate. However, when using L4S configurations, as shown in FIG. 3 and FIG. 4, the ECT profile allows a host application server to distinguish L4S and classic traffic using an identifier of ECT(1) and CE codepoints of the ECN field. ECN is defined in RFC3168 (2001) which allows end-to-end (E2E) notification of network congestion without dropping packets.

Congestion control algorithm module 235 may be configured to apply a congestion control algorithm to the first wireless network. By way of non-limiting example, the first congestion control algorithm may be one of Data Center Transmission Control Protocol (DCTCP), Transmission Control Protocol (TCP) Prague, an L4S variant of the RTP Media Congestion Avoidance Techniques (RMCAT) Self-Clocked Rate Adaptation for Multimedia (SCReAM) controller and the L4S ECN part of Bottleneck Bandwidth and Round-trip propagation time version (BBRv2) intended for TCP and Quick UDP Internet Connections (QUIC) Transport.

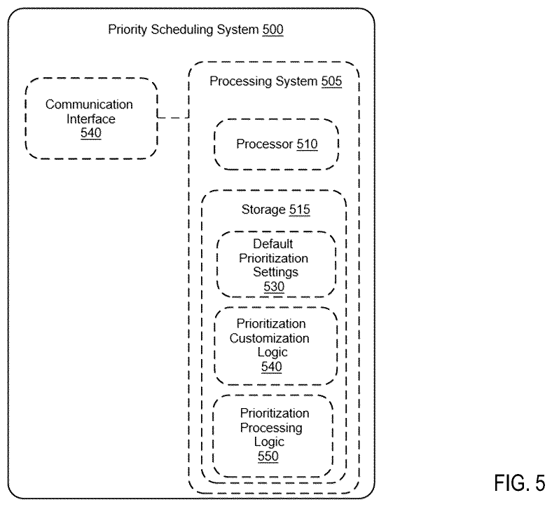

FIG. 5 illustrates a priority scheduling system 500 in accordance with embodiments described herein. The components described herein are merely exemplary as many different configurations for the priority scheduling system 500 may be implemented. The priority scheduling system 500 may be configured to perform the methods and operations disclosed herein to implement a user-controlled priority scheduling. In the disclosed embodiments, the priority scheduling system 500 may be integrated with each access node 110, integrated with the wireless devices 120, 121, 123, and 130 integrated with the core network 102 or may include an entirely separate component capable of communicating with at least the wireless devices 120, 121, 123, and 130 the RAN 170, and the communication network 101. Further, the components of the priority scheduling system 500 may be distributed so that one or more components are located at an access node 110 and one or more other components are located within a separate processing node and/or at the wireless devices 120, 121, 123, and 130.

To perform processes for priority scheduling, the priority scheduling system 500 may utilize a processing system 505. Processing system 505 may include a processor 510 and a storage device 515. Storage device 515 may include RAM, ROM, disk drive, a flash drive, a memory, or other storage device configured to store data and/or computer readable instructions or codes (e.g., software). The computer executable instructions or codes may be accessed and executed by processor 510 to perform various methods disclosed herein.

Software stored in storage device 515 may include computer programs, firmware, or other form of machine-readable instructions, including an operating system, utilities, drivers, network interfaces, applications, or other type of software. For example, software stored in storage device 515 may include a module for performing various operations described herein. For example, in some embodiments, default prioritization settings 530 may include default settings for prioritization of applications, services, and/or devices.

Processor 510 may be a microprocessor and may include hardware circuitry and/or embedded codes configured to retrieve and execute software stored in storage device 515. The priority scheduling system 500 further includes a communication interface 520. Communication interface 520 may be configured to enable the processing system 505 to communicate with other components, nodes, or devices in the wireless network.

The location of the priority scheduling system 500 may depend upon the network architecture. As set forth above, the priority scheduling system 500 may be located in an access node 110, in a separate processing node, in the RAN 170, in multiple locations, or may be an entirely discrete component. Further, although shown as a single integrated system, the functions of storing default settings, prioritization customization, and prioritization processing may be separated and disposed in separate locations.

Accordingly, the system 500 includes a storage device 515 storing instructions and data. The data includes default prioritization settings 530 for applications and services utilized by multiple wireless devices in a wireless network.

The prioritization processing logic 550 adjusts the default prioritization settings and provides a customized prioritization scheme for a wireless device based on manipulation of the default prioritization scheme or entry of the customized priority scheme through the wireless device interface. The prioritization processing logic 550 may trigger a message to an access node 110 to ensure that the requesting wireless device receives the customized priority requested.

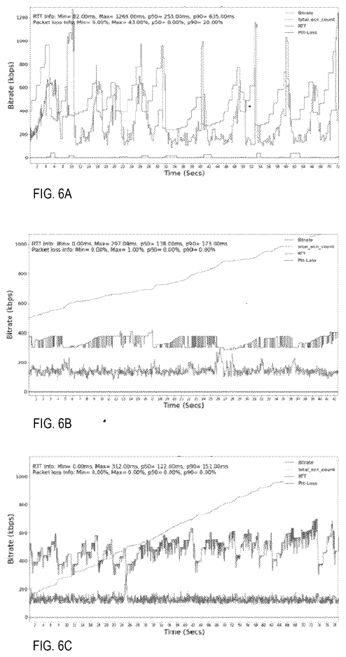

FIGS. 6A-C depict examples of network performance in different instances of congestion and priority. FIG. 6A shows an example of network traffic congestion with no L4S applied. The ECN field in the IP header, shown in FIGS. 3 and 4, may remain at zero, thereby keeping the L4S capability inactive. As the bitrate is not reduced, the roundtrip time (RTT) that it takes for data packets to travel from a source to a destination and back again during congestion is high in certain moments when the bitrate is also high. Accordingly, the network cannot handle the high bitrate for the long RTT duration, and the network drops data packets, i.e., the packet loss in FIG. 6A is greater than zero.

FIG. 6B illustrates an example of L4S being enabled, e.g., the ECN field in the IP header having a value “11” (See FIG. 4). As a result, the processor 510 uses the designated ECN value to determine that congestion is experienced, the L4S feature is activated, and the L4S data packets are marked to signal to the sender to slow down transmission. In this manner, as shown in FIG. 6B, the ECN count rate increases, and the RTT is controlled in a lower range as compared with FIG. 6A, thus allowing the network to transmit the data packets without packet loss, which shows steady at zero value. Nonetheless, the comparison between FIGS. 6A and 6B indicates that the cost of not dropping the data packets is a visibly lower bitrate in FIG. 6B. While the applications/devices/services marked as L4S would not freeze due to the reliable packet transmission, the L4S applications/devices/services could experience lowered resolution because of the decreased bitrate, thus appearing with less clarity and with blurry images as compared to an instance when no congestion is experienced.

FIG. 6C shows an example embodiment applied to the instance when congestion is experienced and the L4S capability is enabled. To prevent image distortion/lack of clarity during the L4S data transmission, the applications/devices/services marked as L4S may be prioritized in the network traffic. The processor 510 may provide a selection of applications, service and devices. The services and applications may include, for example gaming applications, online meetings, streaming video, augmented reality (AR), virtual reality (VR), messaging applications, file transfer applications, or voice calls. The devices may include, for example, IoT devices or eMBB devices, Multiple IoT and eMBB devices may be prioritized by a single wireless device. For example, within a household, IoT devices may include security cameras and other appliances, and eMBB devices may include wireless phones for multiple individuals and multiple purposes.

The processor 510 may further provide ordering and/or ranking options for the applications, services, and devices. The options may allow arrangement in the order of priority. Alternatively, the interface may allow matching of services, application, or devices with a level of service. The levels of service may include, for example, different quality class identifiers (QCI) or 5G quality of service identifiers (5QI). Existing QCIs and 5QIs include 1-9. QCIs and 5QIs are generally allocated by network service providers by default. For example, guaranteed bit rate (GBR) traffic is often assigned to 5QIs or QCIs 1-4 and non-GBR traffic is therefore assigned to 5QIs or QCIs 5-9. GBR traffic includes, for example voice calls, video calls, live gaming, and video streaming. Non-GBR traffic includes, for example, file transfer applications and buffered video. QCI and 5QI values are based on requirements including latency, packet loss, and reliability.

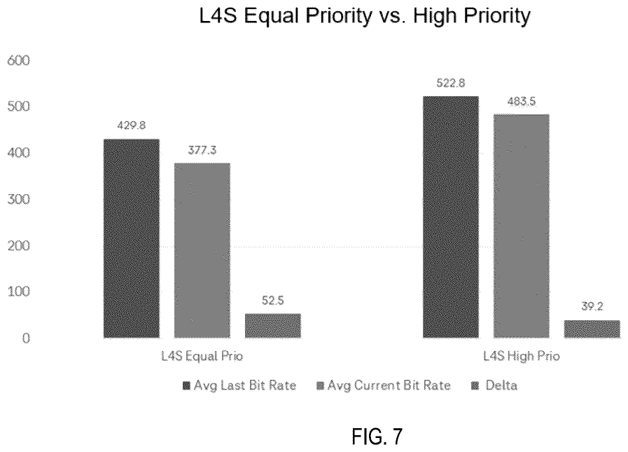

Consequently, the prioritization of the L4S labeled applications, services, and devices shields them from the rest of the network congestion, and their transmission bitrate may be set significantly higher than in a typical L4S, with the risk of packet loss remaining low. Such data packet prioritization results in a low RTT for the prioritized L4S applications, services, and devices with zero packet loss, as shown in FIG. 7C. At the same time, the higher bitrate of the prioritized L4S traffic results in increased resolution of the L4S marked applications/devices/services thereby providing enhanced quality of experience to the user. As soon as the network congestion seizes, the processor 510 may provide instructions to the priority scheduling system to return to the normal priority.

FIG. 7 shows comparison between bit rates in L4S configuration with and without prioritization. The average last bitrate and the average current bitrate can be used as metrics to evaluate the performance of data transmission, for example, in streaming, networking, or file transfer applications. Minimizing the differential between the last and the current bitrate is preferred when stability and consistency are critical. In FIG. 7, the bitrate for the high-priority L4S is higher overall than the bitrate for the equal, i.e., non-prioritized L4S, for the reasons explained above. At the same time, the bitrate differential from the last to the current bitrate shows as 39.2 for the high-priority L4S, thereby demonstrating more stable network performance, smoother data transmission, and fewer quality fluctuations, as compared to the bitrate differential of 52.5 for the non-prioritized L4S.

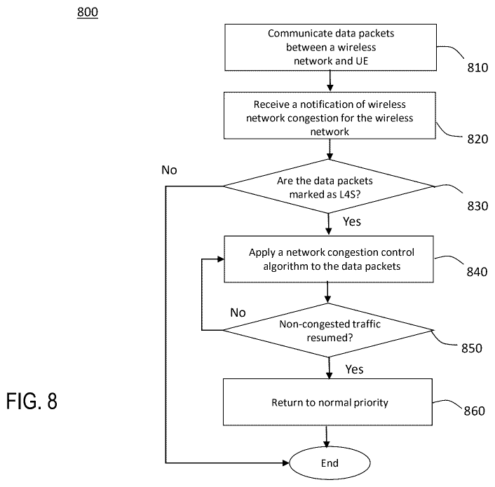

FIG. 8 illustrates an exemplary method 800 for providing network congestion control by prioritizing network traffic. Method 800 starts in step 810, in which data packets are communicated between a wireless network and UE. In step 820, processor 510 receives a notification that the wireless network is congested. For example, value “11” of the two bits in the ECN field in the IP header is provided to the processor 510 to determine that congestion is experienced. Next, a L4S network profile may be configured in the wireless network for different data packet types to address the congestion. The L4S profile allows different congestion control algorithms to be applied to different data packet types to reach the best resource utilization, saving deployment cost for mobile network operators (MNO).

In step 830, the processor 510 determines whether the L4S feature is activated, where the L4S data packets are marked to signal to the sender that L4S is enabled. If the processor 510 renders an affirmative decision, in step 840, a network congestion control algorithm is applied to the L4S data packets. In one implementation, the network congestion control algorithm comprises priority scheduling of the data packets. Further, processor 510 may provide a selection of applications, service and devices. The services and applications may include, for example gaming applications, online meetings, streaming video, augmented reality (AR), virtual reality (VR), messaging applications, file transfer applications, or voice calls. The devices may include, for example, IoT devices or eMBB devices, Multiple IoT and eMBB devices may be prioritized by a single wireless device.

In step 840, processor 510 may further provide ordering and/or ranking options for the applications, services, and devices. The options may allow arrangement in the order of priority. Alternatively, the interface may allow matching of services, application, or devices with a level of service. Consequently, the prioritization of the L4S labeled applications, services, and devices separates them from the rest of the network congestion, and their transmission bitrate may be set significantly higher than in a typical L4S, with the risk of packet loss still being minimal. The data packet prioritization results in the higher bitrate of the prioritized L4S traffic, thus providing increased resolution of the L4S marked applications/devices/services.

In step 850, the processor 510 determines whether the network congestion is no longer present, and if non-congested network traffic resumes, in step 860, the processor 510 provides instructions to the priority scheduling system to return to the normal priority.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

All terms used in the claims are intended to be given their broadest reasonable constructions and their ordinary meanings as understood by those knowledgeable in the technologies described herein unless an explicit indication to the contrary is made herein. In particular, the use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A system comprising:
one or more hardware processors configured by machine-readable instructions to:
communicate data packets between a wireless network and user equipment (UE);
receive a notification of wireless network congestion for the wireless network;
determine the data packets are low latency, low loss, scalable (L4S); and
apply a network congestion control algorithm to the data packets,
wherein the network congestion control algorithm comprises priority scheduling of the data packets.

2. The system of claim 1, wherein the notification of wireless network congestion indicates a congestion control threshold has been satisfied for the wireless network.

3. The system of claim 1, wherein a mechanism for the notification of the wireless network congestion is Explicit Congestion Notification (ECN).

4. The system of claim 3, wherein the one or more hardware processors is configured to determine whether the data packets are L4S by using two bits in an internet protocol (IP) header.

5. The system of claim 4, wherein the two bits in the IP header comprise an ECN field, and wherein the ECN field has a plurality of ECN field values, one of the plurality of the ECN values indicating wireless network congestion.

6. The system of claim 5, wherein the one or more hardware processors is configured to process the one of the plurality of the ECN values indicating wireless network congestion while maintaining application data rate of the data packets.

7. The system of claim 6, wherein the one or more hardware processors is configured to maintain the application data rate of the data packets in a L4S configuration profile by the priority scheduling of the data packets.

8. The system of claim 1, wherein the priority scheduling of the data packets comprises a priority selection of services, applications, and/or devices.

9. The system of claim 8, wherein the priority scheduling of the data packets further comprises ordering and/or ranking options for the applications, services, and devices.

10. The system of claim 1, wherein the priority scheduling of the data packets comprises relative priority scheduling and/or absolute priority scheduling of applications, services, and devices.

11. A method for congestion control in a wireless network, the method comprising:
communicating data packets between the wireless network and user equipment (UE);
receiving a notification of wireless network congestion for the wireless network;
determining the data packets are low latency, low loss, scalable (L4S); and
applying a network congestion control algorithm to the data packets,
wherein the network congestion control algorithm comprises priority scheduling of the data packets.

12. The method of claim 11, wherein the notification of wireless network congestion indicates a congestion control threshold has been satisfied for the wireless network.

13. The method of claim 11, wherein a mechanism for the notification of the wireless network congestion is Explicit Congestion Notification (ECN).

14. The method of claim 13, further comprising determining whether the data packets are L4S by using two bits in an internet protocol (IP) header.

15. The method of claim 14, wherein the two bits in the IP header comprise an ECN field, and wherein the ECN field has a plurality of ECN field values, one of the plurality of the ECN values indicating wireless network congestion.

16. The method of claim 15, further comprising processing the one of the plurality of the ECN values indicating wireless network congestion while maintaining application data rate of the data packets.

17. The method of claim 16, further comprising maintaining the application data rate of the data packets in a L4S configuration profile by the priority scheduling of the data packets.

18. The method of claim 11, wherein the priority scheduling of the data packets comprises a priority selection of services, applications, and/or devices.

19. The method of claim 18, wherein the priority scheduling of the data packets further comprises ordering and/or ranking options for the applications, services, and devices.

20. A non-transitory computer-readable medium storing instructions that when executed by a processor cause the processor to perform operations comprising:
communicating data packets between a wireless network and user equipment (UE);
receiving a notification of wireless network congestion for the wireless network;
determining the data packets are low latency, low loss, scalable (L4S); and
applying a network congestion control algorithm to the data packets,
wherein the network congestion control algorithm comprises priority scheduling of the data packets.
